(19) United States
(12) Patent Application Publication
(10) Pub. No.: US 2015/0375390 A1
(43) Pub. Date: Dec. 31, 2015

(54) ROBOTIC SYSTEM FOR APPLYING SURFACE FINISHES TO LARGE OBJECTS

(71) Applicant: Encore Automation, Auburn Hills, MI (US)

(72) Inventors: Steven Becroft, Metamora, MI (US); Jeffrey R. Joyce, Livonia, MI (US); Arthur P. Scafe, Metamora, MI (US); Michael E. Reich, Grosse Pointe Park, MI (US); Sean P. Parke, Berkley, MI (US); Kevin M. Wichers, Clarkston, MI (US)

(21) Appl. No.: 14/640,749

(22) Filed: Mar. 6, 2015

Related U.S. Application Data
(60) Provisional application No. 61/948,969, filed on Mar. 6, 2014.

(51) Int. Cl. B25J 9/16; B08B 3/04; B05C 9/10; B24B 51/00

(52) U.S. Cl. CPC B25J 9/162; B24B 51/00; B08B 3/04; B05C 9/10; Y10S 901/01; Y10S 901/16; Y10S 901/41

(57) ABSTRACT

A robotic system for performing surface finishing processes on a large object, is provided, the system includes at least one platform having a connected robot, the robot performing a surface finishing process on the large object. Also included is an automatic guided vehicle (AGV) separable of the platform movable independent of the platform for moving under the platform, lifting up the platform and moving the platform multiple locations along or around the large object to extend a useful working envelope of the robot.

### FIELD OF THE INVENTION

There is an increasing need for robotic application of finishes to very large objects. On commercial aircraft for example, it is important to minimize the added weight of coatings, as well as control the consistency of the thickness of coatings for consistency of electrical resistance to electrostatic charge conduction. There is also an increased interest in more consistent, high quality finishes on executive aircraft that is only possible by robotic application. There is also economic pressure to reduce the large cost of manual labor involved in applying finishes to large objects. This invention provides the means to robotically perform surface finishing operations (inclusive of surface preparation including but not limited to sanding, washing, priming and chemical treating, surface filing, surface roughing) to large objects while overcoming the practical limitations that currently exist in the industry.

### BACKGROUND OF THE INVENTION

Robotic surface finishing operations such as sanding, washing and painting have been applied to large objects in the past by a number of means. One means has been to mount robots to large extended axis machines such as gantry cranes or floor supported rails in order to extend the limited reach of a typical 6-axis robot. Another means has been to mount a robot on a platform that moves along a fixed track that follows the contour of the part to be finished, thus allowing the robot to extend its useful envelope. Yet another means has been to mount a robot to a mobile platform such as a wheeled vehicle in order to extend the reach of the robot. While these solutions have been implemented, they have the following limitations: They are very costly and impractical for large complex shapes like a fully assembled commercial aircraft. They tend to be specific for a given large object to be processed and are not flexible enough by design to handle a broad range of sizes and shapes of large objects. A further limitation to the current state of the art is that of expandability. It is very difficult and costly if more robots need to be added to increase throughput or extend the system to process a larger object.

### SUMMARY OF THE INVENTION

The invention herein described is a robotic system for performing surface finishing operations to large objects. The essential elements of the invention are; a plurality of movable platforms that include a robot and its associated support equipment for performing surface finishing operations such as washing, sanding or coating for example, a common means of moving these plurality of platforms (such as an automatic guided vehicle) about a work space such as a large aircraft hangar or marine ship yard, and a means of powering the robot platforms at their various locations in the workspace. Additionally, a means is disclosed of maintaining power to the robot platforms while they are being relocated to a new position. Those skilled in the art will understand that typically, surface finishing processes are performed in a potentially explosive or flammable atmosphere and therefore a safe means of powering the movable robot platforms in a flammable or explosive atmosphere is included in this invention.

It will be understood that the disclosed system is highly flexible as the movable robot platforms can be moved to various locations about an object without the limitations of fixed rails or other mechanical constraints. Also, the platforms can be unique and customized for various operations or reach requirements. The platforms also can be sidelined for maintenance and a spare platform can be brought in as a replacement. The system is economically efficient because the placement and relocation of the robot platforms is performed by an independent entity (an AGV in the preferred embodiment) so that each robot platforms need not include the cost associated with independent mobility. One AGV can service a number of robot platforms. Additionally, because of the complete mobility and flexibility of the system, robot platforms and AGV's could be shared between two work environments. For example, two adjacent aircraft hangers could share movable robot platforms and AGVs.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating. Accordingly:

FIG. 1 illustrates a movable platform 1 which includes a 6-axis robot arm 2, which in turn is mounted to a group of auxiliary motion axis which in this embodiment includes a vertical axis 3, a rotational axis 21, and a horizontal axis 4. The auxiliary axis being functional to enlarge the working envelope of the robot 2 for a given location of the movable platform 1. Additionally the movable robot platform shown in FIG. 1 includes support equipment including the following components: A robot control panel 8, a process control panel 5, a compressed air reservoir 7, and an energy storage pack 6 to provide electrical power to the platform while not connected to outside power such as when it is being relocated.

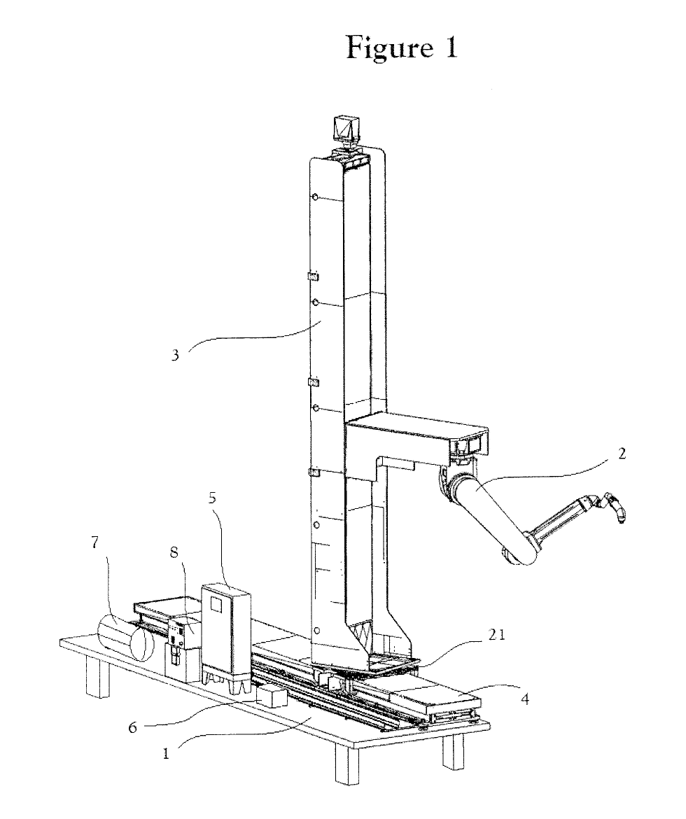

FIG. 2 illustrates a movable platform 1 which includes a 6-axis robot arm 2, mounted on auxiliary motion axis 3,21,4 which provide the following extended motions: Vertical 13, Horizontal 12, and rotational 14. An automatic guided vehicle (hereafter AGV) 9 is shown in two alternate positions approaching the movable platform 1 from either of two directions (45 and 46), in order to travel beneath the movable platform (1). The AGV in this embodiment includes powered casters 11, and platform lifting points 10 functional to lift the movable platform in order to move it from one location to another.

FIG. 3 illustrates two movable robot platforms 1 that include 6-axis process robot arms 6, an AGV 9 for transporting the movable platforms 1, around and along a large object 18 in this embodiment a large commercial aircraft. Further illustrated is a power and communication network 17 including plug-in points 16, and a power distribution control center 19. Further shown is a means to connect the movable platform 1 into the plug-in point 16 via a plug in connector 15 mounted to the movable platform 1. The movable platforms 1 is supported by support columns 20, which may be located over lock down anchors 22 (FIG. 4) to eliminate tipping or instability of the movable platform 1 under dynamic conditions.

FIG. 4 illustrates a movable robot platform 1 supporting a process robot 2 supported by axillary axis (2 and 3), a plug-in power and communication connection means 15 mounted to the movable robot platform 1. A plurality of positionally fixed plug-in connection points 16 are shown such that the movable platform 1 could be moved to various locations around a large object 18 in order to extend the working envelope of the process robot 2. A power, communication and utility network 17 provides power, communication and any required utilities such as compressed air or process liquids required to the movable robot platform 1 through the pug-in points 16 and the plug-in means 15. Further shown are lock down anchor points 22 which allow the support columns 20 to be securely fixed to the ground in order to provide stability to the platform 1 under dynamic conditions.

FIG. 5 illustrates a movable robot platform 1 supporting a process robot 2 supported by axillary axis (2 and 3), the movable robot platform 1 being shown supported by an AGV 9. The AGV 9 being functional to move/relocate the robot platform 1.

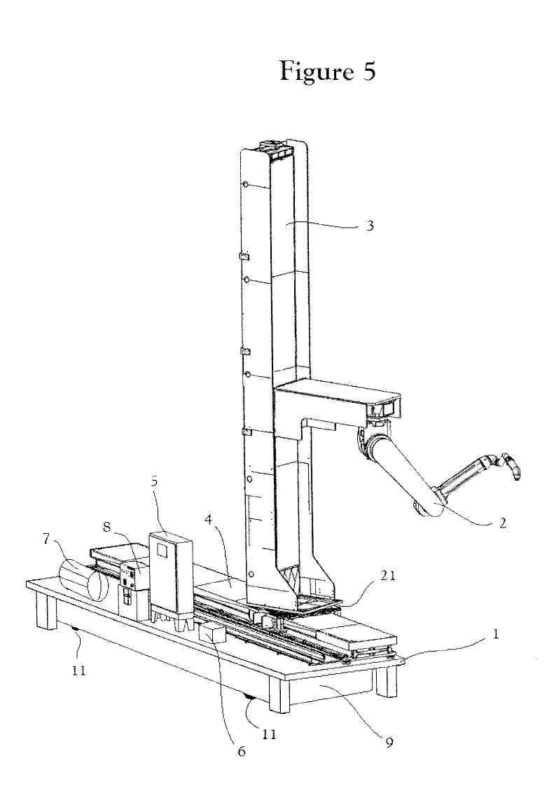

### DETAILED DESCRIPTION OF THE PREFERRED EMBODIMENTS

The following description of the preferred embodiment(s) is merely exemplary in nature and is in no way intended to limit the invention, its application, or uses.

The preferred embodiment of this invention is a system of movable robot platforms 1 that allow for a flexible solution to performing surface process treatments such as (but not limited to) washing, scrubbing, sanding or painting to large objects such as commercial aircraft. The robot platforms will include a commercially available 6 axis robot arm 2 which may be mounted to extended auxiliary axis such as a vertical lift 3 which includes a rotational axis 21 and a linear translation axis 4. The platform 1 will carry the equipment necessary to support the robot operations. This support equipment will typically be a robot controller panel 8, a process control panel 5 for controlling the process equipment such as a paint applicator or robotic sanding head, a compressed air tank 7 for a temporary compressed air source for times when the platform is not connected to an outside source, and a battery pack 6 for temporary electrical power for when the platform is not connected to an outside electrical power source (when it is being transported between work positions for example). One that is skilled in the art would understand the temporary sources of air and electrical power could also be supplied by flexible hoses and cables that are connected to the movable platform form a fixed outside source.

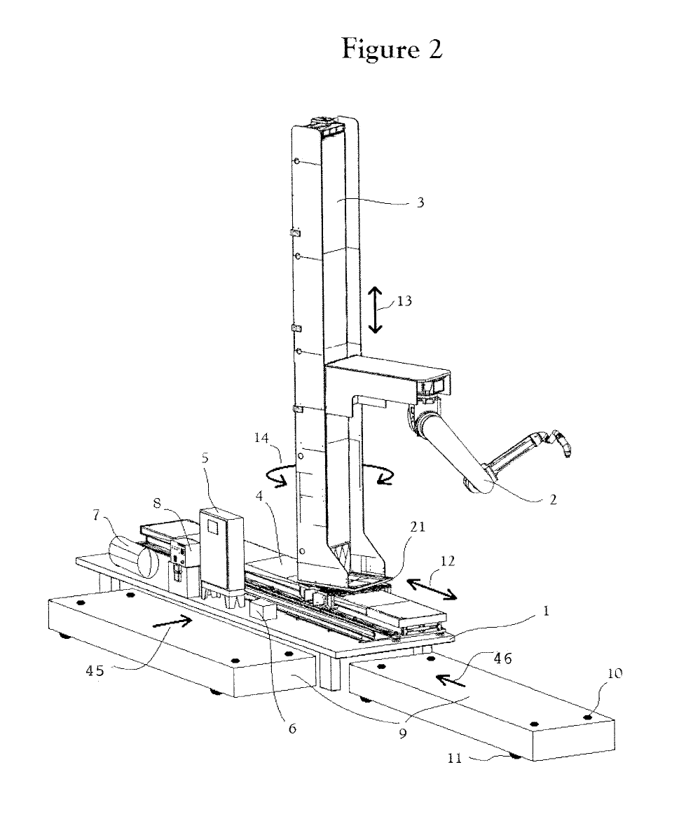

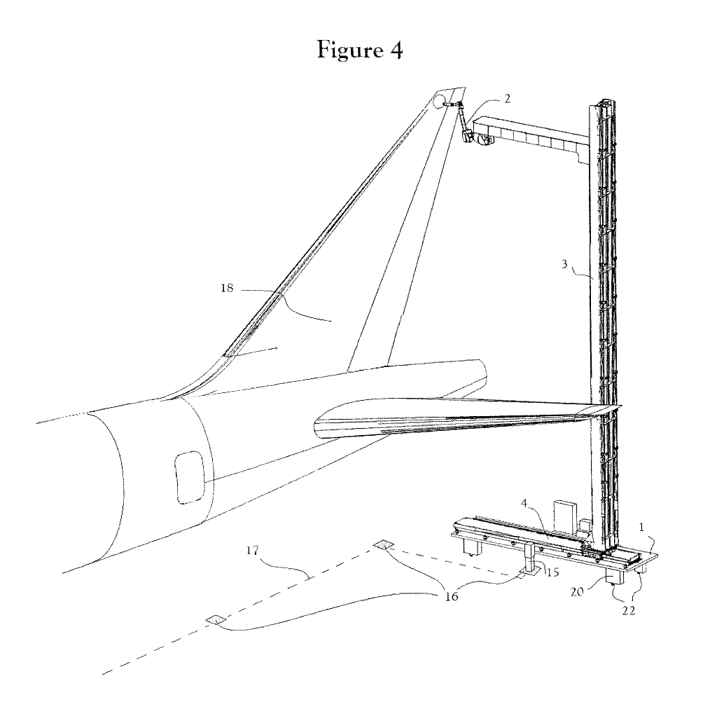

The preferred method of moving the robot platforms about a work area is by an Automatic Guided Vehicle (AGV) 9 which has connected lifting mechanisms 10 allowing it to move under the robot platform and lift it in order to relocate it to a new work location (illustrated in FIGS. 2 and 4). The robot platform 1 can also be manually moved with a fork lift truck or other means. The robot platform can be moved along tracks in the floor or a tug along. In an alternative embodiment, item 10 can also be locator receptacles for extendable pins that are connected on the platform 1. The AGV 9 is guided around the work area by traditional methods such as magnetic strips embedded in the floor of the work area or a dedicated local radio GPS operable to send position and direction data to the AGV.

The system includes a power and utility distribution grid 17 that supplies the robot platforms with electrical power and compressed air for example, once the platform is positioned at a work area. The distribution grid includes a distribution control panel or center 19 that is located outside the hazardous or flammable work environment. The grid 17 includes connection points 16 at strategic locations along and around the large object to be processed such as an aircraft 18. The movable robot platform 1 has a plug-in connection means 15 that enables the platform to receive power, utilities, and communication through the distribution grid 17 from the distribution control panel 19. The connection point 16 and plug-in means 15 will require either a purge enclosure or explosion proof connectors due to the hazardous environment. One skilled in the art will understand the requirements for power connections in hazardous locations. In the preferred embodiment the power distribution control panel 19 will maintain the connection points 16 in a safe unpowered state until it senses through an intrinsically safe sensor that the platform connection means is engaged via explosion proof connections, at which point the distribution panel will allow power to connect to the platform 1.

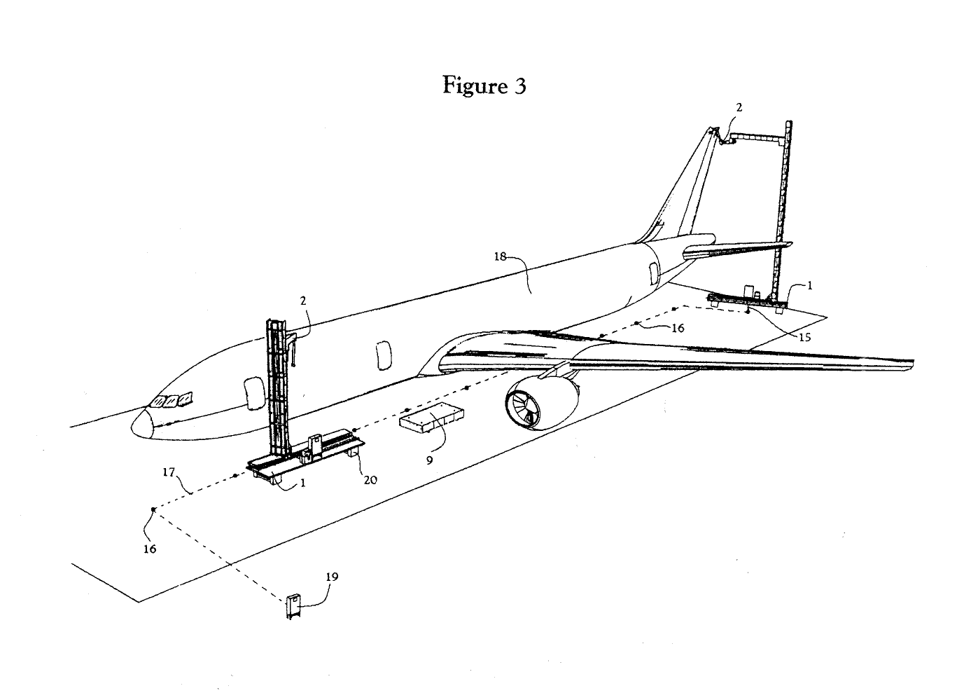

The movable robot platforms 1 can be customized for specific duties. For example in FIG. 3 two robot platforms are shown with different t vertical auxiliary axis heights in order to perform different operations. In the example shown in FIG. 3, one robot platform has a taller vertical reach in order to reach the top of the vertical stabilizer of a commercial aircraft. FIG. 3 also illustrates two robot platforms 1 and one AGV 9 available to move either robot platform.

The following sequence describes the operation of the preferred embodiment. For a large commercial aircraft painting operation the aircraft is typically positioned in a large paint hanger. The robotic painting system herein described would operate as follows: While the aircraft is transferred into the hanger the movable robotic platforms 1 and AGV 9 will be positioned in areas of the hanger so as to be out of the way and allow free uninhibited movement and positioning of the aircraft 18. Once the aircraft is located either in a known predetermined location or its location identified by a position identification system such as a vision or laser measurement system (not part of this invention), The AGV 9 then moves to and positions itself under a robot platform 1, moves the robot platform to a predetermined position near the aircraft and over a power connection plug-in point 16, and lowers the robot platform unto lock-down anchor points 22. The lock down anchor may be a mechanism that moves an anchor connected with the platform into a hook type device or striker attached with the floor, or in other applications may be an extendable latch that connects with a striker fixed to the platform. Even after the platform 1 has been locked down, there is clearance AGV 9 to remove itself from under the platform 1. The AGV 9 then proceeds to another movable robot platform 1 and repeats the sequence. When the robot platforms are locked into position near the aircraft, the plug in means 15 are actuated to engage connections embedded in the network connection points 16 for utilities such as electrical power, communication, and any other utilities such as compressed air that are required. For safety reasons, the electrical connections remain un-energized until the connections are complete. When the power, communication and utility network 17 control panel 19 senses via an intrinsically safe sensor, that the robot platform is plugged in, power is turned on to that connection point to supply control power and communication to the robot platform 1.

In the preferred embodiment the robot platform will have a temporary power supply on board to maintain power to the robot controller 8 and the process control panel 5 as necessary during periods when the robot platform is not plugged into the power and communion distribution network 17. Additionally, the robot platform will have a supply of stored compressed air on board to supply purge air to the robot while it is not plugged into the power, communication and utility network. Having temporary utilities on board allows the robot to begin operation quickly upon repositioning rather than go through time consuming power up sequences. When the movable robot platform is positioned, the robot can begin its painting (or sanding. Washing etc) process and work independently until it completely processes the area that it can reach from the current platform location. When complete, the robot controller sends a signal to the network control panel which in turn requests a position move to the AGV.

As many movable robot platforms as required to complete the overall process in a required cycle time may be employed. Each movable robot platform may complete a number of sections of the aircraft or large object by being moved from one location to another along and around the aircraft or other large object to be processed. Robot platforms may differ from one another in that they may be uniquely fitted to perform specific functions. For example, the highest point of an object may be a small area that only requires one robot platform to have the vertical reach required to process that area. In this case there may be a number of robot platforms that process the bulk of the aircraft and only one or two platforms fitted to reach the top of the vertical stabilizer for example.

In aircraft painting operations it is often the case that between coats of paint the aircraft is subjected to elevated temperatures to accelerate the cure of the coating. The elevated cure temperature required is sometimes higher than the process equipment mounted to the robot platform is designed to endure. It should be obvious that this invention has the distinct advantage of allowing the robot platforms to be removed from the painting area and into a separate room for example, while the temperature of the environment around the aircraft is elevated to cure the coating.

It is also a distinct advantage of this invention that robot platforms may be added or subtracted from the system as needed, and even shared between adjacent paint systems as needed. It is also an advantage that a robot platform can be set aside for repair or maintenance without adversely affecting the overall system, by having spare robot platforms that can be rotated in or out of service.

It is clear that many variations of the invention may be envisioned. Movable robot platforms could be manually moved into position for example instead of employing an AGV. Power and utilities could be supplied to the robot platform by overhead cables and hoses festooned from the ceiling or pulled across the ground for example instead of utilizing the power, communication and utility network herein described. Conversely, robot platforms could be powered by larger onboard energy storage packs (battery packs for example) that allow the platform to remain unconnected to the larger system while performing processing duties. These battery packs could either be recharged or traded for fully charged ones between process duties.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A robotic system for performing surface finishing processes on a large object, said system comprising:
at least one platform having a connected robot, said robot performing a surface finishing process on said large object, an automatic guided vehicle (AGV) separable of said platform movable independent of said platform for moving under said platform, lifting up said platform and moving said platform multiple locations along or around said large object to extend a useful working envelope of said robot.

2. The robotic system of claim 1 wherein said robotic process is taken from the group of surface finishing processes including sanding, washing, painting, priming, chemical treating, surface filing, surface roughing.

3. The robotic system of claim 1 having a plurality of platforms.

4. The robotic system of claim 1 wherein said platform plugs in to a locationally fixed utility distribution network to receive a utility when said platform is positioned by said AGV.

5. The robotic system of claim 4 wherein said platform has located thereon a temporary storage of said utility for utilization by said robot when said platform is separated from said utility distribution network and said platform is being moved by said AGV.

6. The robotic system of claim 1 wherein said AGV can be controlled by at least one of a group of control techniques including following floor guides, ground positioning radio, or lasers.

7. The robotic system of claim 1 wherein said platform has positioned thereon a storage of surface finishing supplies.

8. The robotic system of claim 1 wherein said platform can be locked with the floor.

9. The robotic system of claim 4 wherein a controller of the flow of said utility is remote from said platform.

10. The robotic system of claim 9 wherein said controller does not allow utility flow unless there is confirmation of a proper physical connection of said utility from said network to said platform.

11. The robotic system of claim 1 wherein said platform has position thereon a process controller for a finishing operation.

12. A robotic system for performing surface finishing processes on a large object, said system comprising:
at least one manually moveable platform having a connected multi-axis robot, said robot performing a surface finishing process on said large object, said platform having a controller for said finishing process, said platform having storage for a supply for said finishing process and a capability for locking with a floor said platform is place on, said platform having storage for a utility utilized by said robot.

13. A method for performing surface finishing processes on a large object utilizing a robotic system, said method comprising:
providing at least one platform having a connected multi-axis robot;
performing a surface finishing process on said large object with said robot;
providing an automatic guided vehicle (AGV) separable of said platform and movable independent of said platform;
moving said AGV under said platform;
lifting up said platform from said floor with a mechanism connected to one of said platform and said AGV, and;
moving said platform multiple locations along or around said large object to extend a useful working envelope of said robot.

14. The method of claim 13 further comprising locking said platform with said floor.

15. The method of claim 13 further comprising plugging said platform into a locationally fixed utility distribution network by plugging said platform with said utility distribution network by moving said platform with said AGV.

16. The method of claim 15 further comprising controlling the flow of a utility from said utility distribution network to said platform by a controller remote from said platform.

17. The method of claim 16 further comprising preventing flow of said utility unless there is confirmation of a proper connection between said platform and said utility distribution network.

18. The method of claim 13 wherein said AGV moves multiple platforms.

19. The method of claim 18 further comprising said robots on said multiple platforms differ in size to do perform on different portions of said large object.

20. The method of claim 13 further comprising controlling said AGV by at least one of a group of control techniques including following floor guides, ground positioning radio, or lasers.

21. The robotic system of claim 12 further including:
a positionally fixed utility distribution network, said utility network being plugged into by said platform when said platform is moved; and
a utility flow controller locationally remote from said platform preventing flow of said utility form said utility distribution network to said platform unless confirmation has been received of a proper connection between said utility distribution network and said platform.

22. The robotic system of claim 12 wherein:
said platform can be moved by at least one of a group of techniques, said techniques including an AGV, a manual forklift, a powered forklift, a pull along, or a floor mounted track.
